(19) United States
(12) Patent Application Publication
(10) Pub. No.: US 2023/0015051 A1
(43) Pub. Date: Jan. 19, 2023

(54) Filter Having Multiple Denier Fibers

(71) Applicant: 3M INNOVATIVE PROPERTIES COMPANY, St. Paul, MN (US)

(72) Inventors: Matthew W. Gorrell, South St. Paul, MN (US); Tommie W. Kelley, Shoreview, MN (US); Windy A. Santa Cruz, Minneapolis, MN (US); David C. Raithel, Hudson (MN); John B. Stender, St. Paul, MN (US); Stephen M. Sanocki, Stillwater, MN (US); Yaohua Gao, Woodbury, MN (US); John M. Brandner, St. Paul, MN (US); Joseph A. Dunbar, Woodbury, MN (US)

(21) Appl. No.: 17/757,191

(22) PCT Filed: Dec. 10, 2020
(86) PCT No.: PCT/IB2020/061789

§ 371 Date: Jun. 10, 2022

Related U.S. Application Data
(60) Provisional application No. 62/948,985, filed on Dec. 17, 2019.

(51) Int. Cl. B01D 39/16; B01D 46/12

(52) U.S. Cl. CPC B01D 39/1623; B01D 46/12; B01D 2239/065; B01D 2239/0618; B01D 2277/20; B01D 2239/1291

(57) ABSTRACT

Filter media are described. In particular, a filter media includes an intake side, an exhaust side, and a plurality of fibers distributed throughout the filter media. The fibers have a plurality of deniers, and fibers disposed proximate the intake side have a first denier and fibers disposed proximate the exhaust side have a second denier. The first denier is larger than the second denier.

### BACKGROUND

Filters are used for many purposes, such as removing small suspended particulates from fluid flows. Filters can include fibers having a plurality of deniers.

### SUMMARY

In some aspects, a filter media is disclosed. The filter media can include an intake side, an exhaust side and a plurality of fibers distributed throughout the filter media, and the fibers can have a plurality of deniers. Fibers disposed proximate the intake side can have a first denier and fibers disposed proximate the exhaust side can have a second denier, the first denier can be larger than the second denier.

### BRIEF DESCRIPTION OF THE DRAWINGS

FIG. 1 is schematic system view of a filter securement system including cooking equipment and an exhaust system, according to exemplary embodiments of the present disclosure.

FIG. 2 is an upper perspective view of a filter media, according to exemplary embodiments of the present disclosure.

FIG. 3A is an upper perspective exploded view of a filter media having multiple zones, according to exemplary embodiments of the present disclosure.

FIG. 3B is an upper perspective view of a filter media having multiple zones, according to exemplary embodiments of the present disclosure.

FIG. 4 is an upper perspective view of a filter media, according to exemplary embodiments of the present disclosure.

FIGS. 5A-5F are plots illustrating various denier profiles, according to exemplary embodiments of the present disclosure.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Filters can be used in a wide range of applications. In some embodiments, filters may be designed for general air filtration to filter primarily airborne particulates. For example, filters may be designed to filter particles smaller than 10 micrometers in diameter, smaller than 5 micrometers in diameter, smaller than 2.5 micrometers in diameter, smaller than 1.0 micrometer in diameter, smaller than 0.5 micrometers in diameter or smaller than 0.3 micrometers in diameter, among others.

Filters can also be used in a specific location, such as an exhaust hood, for grease filtering in a commercial cooking environment. In commercial kitchens, grease capture in exhaust hoods may be important for health, safety and environmental reasons. However, grease buildup in and around an exhaust hood or an exhaust system may pose a fire hazard. To mitigate the hazard, commercial kitchens typically use airflow interrupters or disrupters, such as baffles, made of a non-flammable material, such as a metal or metal alloy, including stainless steel, galvanized steel or aluminum. The baffle can prevent fire from spreading between the cooking surface and the exhaust system. Additionally, aerosolized grease can travel through the complicated path created by the baffles and condense on the surfaces, resulting in grease accumulating further up in the ducts. However, this grease buildup on the baffle requires regular cleaning to maintain the baffle's effectiveness as a fire barrier and a grease collector. Aesthetically, visible grease on a commercial hood baffle can also be undesirable. Removing, cleaning, and reinstalling the baffles can be time consuming, labor-intensive, expensive and dangerous. Thus, versus conventional baffles, the present disclosure can provide a grease-trapping solution that reduces or prevents the buildup of grease on exhaust system components, is light and easy to install in an exhaust hood and can facilitate the easy replacement of filter media within an exhaust hood in a location traditionally occupied by baffles. Other benefits and uses are also foreseen.

The present disclosure provides a filter securement system, which can include a filter media. The filter securement system can receive and retain the filter media in an exhaust hood for the filtration of grease droplets, although other uses and locations for the filter media are within the scope of this disclosure. Such a filter securement system, and filter media, can be designed to replace traditional baffles in an exhaust hood, thereby requiring minimal or no modifications to existing exhaust systems. Further, the filter media received and/or secured by the filter securement system can prevent flames from passing through the filter securement system and prevent the buildup of grease on portions of the exhaust system downstream of the filter media. For clarity, moving from the cooking equipment through the exhaust system and past the blower can be defined as moving downstream, while moving in the opposite direction can be defined as moving upstream.

In some embodiments, the filter media includes a plurality of fibers. Each of these fibers can have a particular denier associated therewith. Denier can describe a unit of measurement for a linear mass density of the fiber. In some embodiments, denier can indicate a mass per distance of the fiber, and more specifically can indicate mass (in grams) per 9000 meters of the fiber. As will be described in this specification, various fibers disposed as various locations in the filter media can have different deniers.

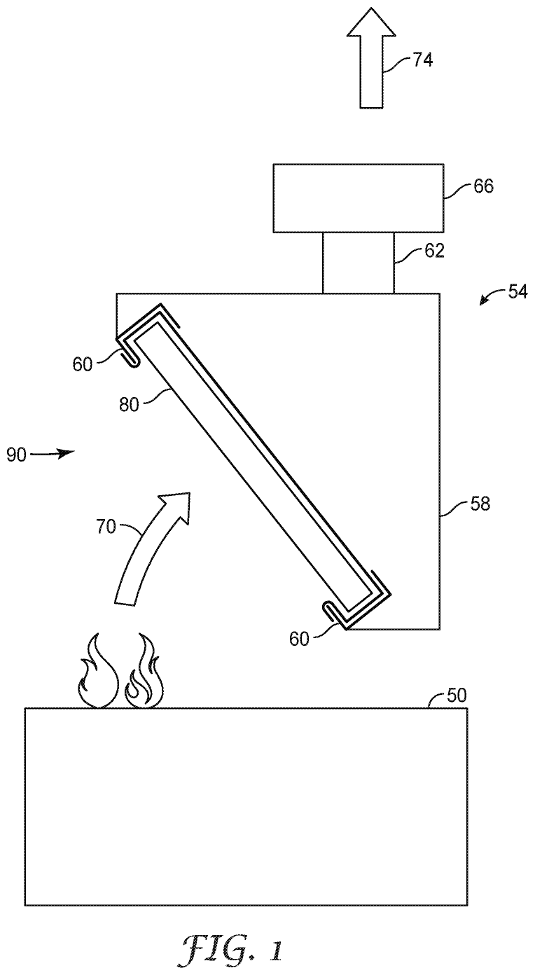

FIG. 1 is a schematic sectional view of a filter securement system 90 including cooking equipment 50 and an exhaust system 54. The cooking equipment 50 can be an oven, stove, grill, fryer, broiler or any other commonly used cooking apparatus known to those skilled in the art. The exhaust system 54 can include an exhaust hood 58 defining an exhaust hood flange 60. The exhaust hood 58 can be positioned to capture all or a portion of grease and other particulates generated by the use of the cooking equipment 50. A blower 66 can, via a duct 62, create a reduced-pressure area proximate the cooking equipment 50 (relative to ambient pressure) that can encourage grease and other particulates generated by use of the cooking equipment 50 to enter the exhaust system 54 via the exhaust hood 58. In such a system, as illustrated in FIG. 1, air, gasses, grease and/or particulates can travel into the exhaust system 54 via the exhaust hood 58 (and filter securement system 90 and filter media 80, as will be described below), as represented by arrow 70. The filtered air, gasses and any remaining grease and/or particulates can then pass through the duct 62 and blower 66 before exiting the exhaust system 54, as represented by arrow 74. It is to be understood that filter securement systems 90 and filter media 80 releasably mounted on, proximate, adjacent and/or in contact with the exhaust hood flange 60 or exhaust hood 58 are within the scope of this disclosure.

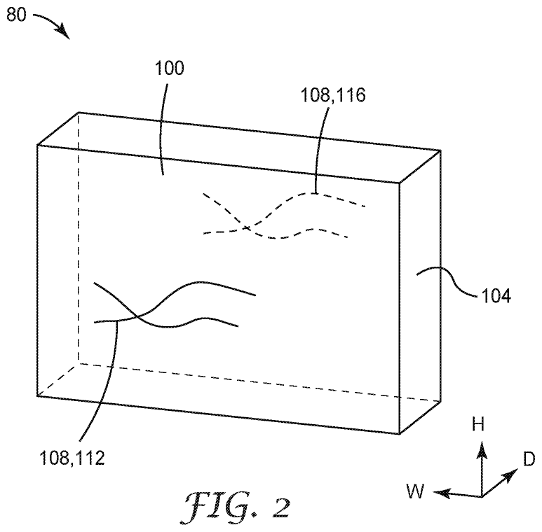

FIG. 2 illustrates a schematic perspective view of the filter media 80. The filter media 80 can define an intake side 100. The intake side 100 can be a side from where a fluid flow enters the filter media 80. In some embodiments, the intake side 100 can be a side facing the cooking equipment 50 and/or facing upstream within the filter securement system 90. The filter media 80 can also define an exhaust side 104. The exhaust side 104 can be a side where a fluid flow exits the filter media 80. In some embodiments, the exhaust side 104 can be a side facing downstream within the filter securement system 90 and/or facing an interior of the exhaust hood 58. The filter media 80 can define height (H), width (W) and depth (D) directions, as shown in the figures. The depth can be measured substantially along a fluid flow direction through the filter media 80. Further, the intake side 100 can be substantially opposed from the exhaust side 104 on the filter media 80.

Fibers 108 can, wholly or partially, form the filter media 80. In some embodiments some fibers 112 can be disposed at the intake side 100. In some embodiments, the fibers 112 can be disposed proximate the intake side 100. In various embodiments, the fibers 112 can be disposed at least, at most, at or about: 0 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm or 25 mm from the intake side 100. In some embodiments some fibers 116 can be disposed at the exhaust side 104. In some embodiments, the fibers 116 can be disposed proximate the exhaust side 104. In various embodiments, the fibers 116 can be disposed at least, at most, at or about: 0 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm or 25 mm from the exhaust side 104.

In some embodiments, the fibers 112 have a first denier and the fibers 116 have a second denier. In various embodiments, the first denier is larger than, or larger than or equal to, the second denier. In various embodiments, the first denier is, is about, is at most, or is at least: 5%, 10%, 15%, 20%, 25%, 30%, 35%, 40%, 45%, 50%, 55%, 60%, 65%, 70%, 75%, 80%, 85%, 90%, 95%, 100%, 110%, 120%, 130%, 140%, 150%, 160%, 170%, 180%, 190%, 200%, 225%, 250%, 275%, 300%, 400%, 500%, 750%, 1,000%, 2,000%, 5,000%, 10,000%, 20,000%, 30,000%, 40,000%, 50,000%, 75,000% or 100,000% larger than the second denier. In some embodiments, the first denier is, or is about, 200%-5,000% larger than the second denier, inclusive. In various embodiments, the first denier is, is about, is at most or is at least 1, 2, 3, 4, 5, 6, 7, 8, 9, 10, 15, 20, 25, 30, 35, 40, 45, 50, 55, 60, 65, 70, 75, 80, 85, 90, 95, 100, 125, 150, 175, 200, 250, 300, 350, 400, 450, 500, 600, 700, 800, 900, 1,000, 1,500, 2,000, 2,500, 3,000, 3,500, 4,000, 4,500, 5,000, 7,500 and 10,000. It is to be understood that in a given embodiment, the first and second deniers can each have a different denier from this list.

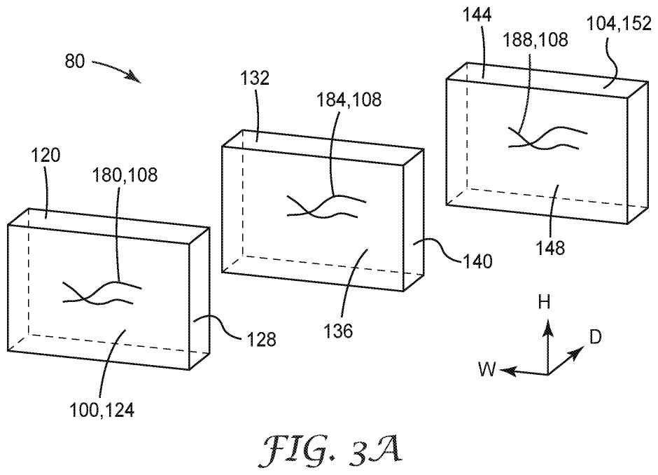

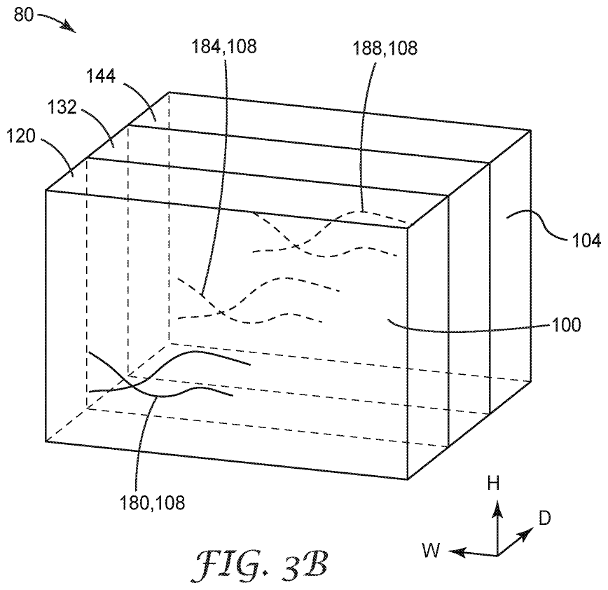

FIGS. 3A and 3B illustrate an embodiment of a filter media 80 having a plurality of zones. In particular, the filter media 80 can include a first zone 120 defining a first zone intake side 124 and a first zone exhaust side 128. The first zone intake side 124 can be a side from which a fluid flow enters the first zone 120 of the filter media 80. In some embodiments, the first zone intake side 124 can be a side facing the cooking equipment 50 and/or facing upstream within the filter securement system 90. The first zone exhaust side 128 can be a side from which a fluid flow exits the first zone 120. Further, the first zone intake side 124 can be substantially opposed from the first zone exhaust side 128 on the first zone 120.

The filter media 80 can also include a second zone 132 defining a second zone intake side 136 and a second zone exhaust side 140. The second zone intake side 136 can be a side from which a fluid flow enters the second zone 132 of the filter media 80. In some embodiments, the second zone intake side 136 can be a side facing the first zone exhaust side 128 and/or facing upstream within the filter securement system 90. The second zone exhaust side 140 can be a side from which a fluid flow exits the second zone 132 and/or a side facing upstream within the filter securement system 90. Further, the second zone intake side 136 can be substantially opposed from the second zone exhaust side 140 on the second zone 132.

The filter media 80 can also include a third zone 144 defining a third zone intake side 148 and a third zone exhaust side 152. The third zone intake side 148 can be a side from which a fluid flow enters the third zone 144 of the filter media 80. In some embodiments, the third zone intake side 148 can be a side facing the second zone exhaust side 140 and/or facing upstream within the filter securement system 90. The third zone exhaust side 152 can be a side from which a fluid flow exits the third zone 144, a side from which a fluid flow exits the filter media 80 and/or a side facing upstream within the filter securement system 90. Further, the third zone intake side 148 can be substantially opposed from the third zone exhaust side 152 on the third zone 144.

As can be seen in FIG. 3B, the zones 120, 132, 144 can each form all or a portion of the filter media 80 as measured along the depth (D) of the filter media 80. In various embodiments, the first zone 120, second zone 132 and third zone 144 can each form at least, at most or about 5%, 10%, 15%, 20%, 25%, 30%, 35%, 40%, 45%, 50%, 55%, 60%, 65%, 70%, 75%, 80%, 85%, 90%, 95% or 100% of the filter media as measured along the depth (D) of the filter media 80. Further, although illustrated as rectangular solids, the zones 120, 132, 144 can be of any shape, and can form any portion of, the filter media 80. Further, the zones 120, 132, 144 can be proximate, adjacent, adhered to, in contact with or on any of the other zones 120, 132, 144.

Fibers 108 can be disposed throughout the filter media 80. In some embodiments, a first zone fiber 180 can be disposed in the first zone 120 and can have a first zone denier. In some embodiments, a second zone fiber 184 can be disposed in the second zone 132 and can have a second zone denier. In some embodiments, a third zone fiber 188 can be disposed in the third zone 144 and can have a third zone denier. In various embodiments, the first, second or third zone deniers are, are about, are at most, or are at least 1, 2, 3, 4, 5, 6, 7, 8, 9, 10, 15, 20, 25, 30, 35, 40, 45, 50, 55, 60, 65, 70, 75, 80, 85, 90, 95, 100, 125, 150, 175, 200, 250, 300, 350, 400, 450, 500, 600, 700, 800, 900, 1,000, 1,500, 2,000, 2,500, 3,000, 3,500, 4,000, 4,500, 5,000, 7,500 and 10,000. It is to be understood that in a given embodiment, the three zone deniers can each be a different denier from this list.

The first zone fibers 180, second zone fibers 184 and third zone fibers 188 can form all of the fibers in the first zone 120, second zone 132 and third zone 144, respectively. In some embodiments, the first zone fibers 180, second zone fibers 184 and third zone fibers 188 can form, can form about, can form at least or can form at most: 5%, 10%, 15%, 20%, 25%, 30%, 35%, 40%, 45%, 50%, 55%, 60%, 65%, 70%, 75%, 80%, 85%, 90% or 95% of the first zone 120, second zone 132 and third zone 144, respectively, or of the fibers in the first zone 120, second zone 132 and third zone 144, respectively.

In various embodiments, the first zone denier is larger than, or larger than or equal to, the second zone denier. In various embodiments, the first zone denier is, is about, is at most, or is at least: 5%, 10%, 15%, 20%, 25%, 30%, 35%, 40%, 45%, 50%, 55%, 60%, 65%, 70%, 75%, 80%, 85%, 90%, 95%, 100%, 110%, 120%, 130%, 140%, 150%, 160%, 170%, 180%, 190%, 200%, 225%, 250%, 275%, 300%, 400%, 500%, 750%, 1,000%, 2,500%, 5,000% or 10,000% larger than the second zone denier. In some embodiments, the first zone denier is from 200%-2,000% greater than the second zone denier, inclusive.

In various embodiments, the second zone denier is larger than, or larger than or equal to, the third zone denier. In various embodiments, the second zone denier is, is about, is at most, or is at least: 5%, 10%, 15%, 20%, 25%, 30%, 35%, 40%, 45%, 50%, 55%, 60%, 65%, 70%, 75%, 80%, 85%, 90%, 95%, 100%, 110%, 120%, 130%, 140%, 150%, 160%, 170%, 180%, 190%, 200%, 225%, 250%, 275%, 300%, 400%, 500%, 750%, 1,000%, 2,500%, 5,000% or 10,000% larger than the third zone denier. In some embodiments, the second zone denier is from 200%-2,000% greater than the third zone denier, inclusive.

In various embodiments, the first zone denier is larger than, or larger than or equal to, the third zone denier. In various embodiments, the first zone denier is, is about, is at most, or is at least: 5%, 10%, 15%, 20%, 25%, 30%, 35%, 40%, 45%, 50%, 55%, 60%, 65%, 70%, 75%, 80%, 85%, 90%, 95%, 100%, 110%, 120%, 130%, 140%, 150%, 160%, 170%, 180%, 190%, 200%, 225%, 250%, 275%, 300%, 400%, 500%, 750%, 1,000%, 2,500%, 5,000% or 10,000% larger than the third zone denier.

In some embodiments, one or more of the first zone fibers 180, second zone fibers 184 and third zone fibers 188 can be disposed within the first zone 120, second zone 132 and/or third zone 144. In such an embodiment, the mixture of, for example, first zone fibers 180 and second zone fibers 184 in the first zone 120 and the mixture of, for example, first zone fibers 180 and second zone fibers 184 in the second zone 132 can promote a more gradual transition between zones by preventing an abrupt change in fiber denier, or in average fiber denier. Further, in such an example, the mixture of first zone fibers 180 and second zone fibers 184 in the first zone 120 can include a majority of first zone fibers 180 and the mixture of first zone fibers 180 and second zone fibers 184 in the second zone 132 can include a majority of second zone fibers 184. Similar concepts and ratios can extend to all zones, or to the interfaces between any of the disclosed zones.

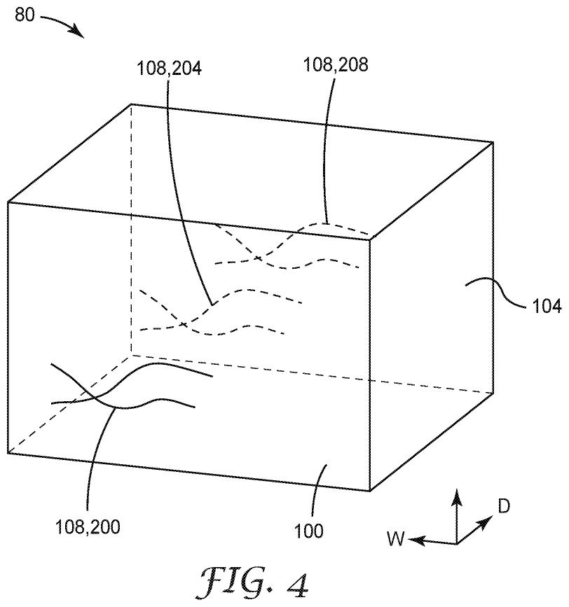

FIG. 4. illustrates an embodiment of the filter media 80 including a plurality of fibers 108. In particular, fibers 200, 204 and 208 are illustrated. It is to be understood that the filter media 80 can include more fibers than fibers 200, 204 and 208, and that fibers 200, 204 and 208 can be disposed in various positions in the filter media 80. Fiber 200 can be disposed closer to the intake side 100 than is fiber 204, and fiber 204 can be disposed closer to the intake side 100 than is fiber 208. Fiber 208 can be disposed closer to the exhaust side 104 than is fiber 204, and fiber 204 can be disposed closer to the exhaust side 104 than is fiber 200.

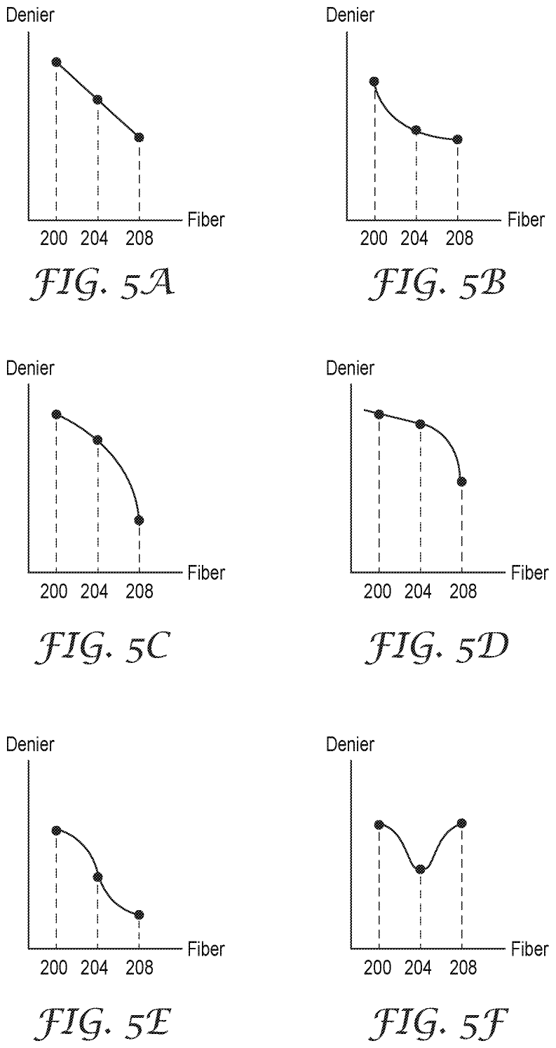

The fibers 200, 204 and 208 can have differing deniers. In some embodiments, the denier can decrease from fiber 200 to fiber 204, and from fiber 204 to fiber 208 in a denier profile, or a plot of denier (Y-axis) versus fiber (X-axis). It is to be understood that additional fibers can be disposed in the three zones, but that fibers 200, 204, 208 are used as exemplary elements to illustrate denier profiles, as described herein. In some embodiments, the denier can decrease from fibers 200 to 204 to 208 in a linear, or substantially linear fashion, as illustrated by the substantially constant slope in the denier profile of FIG. 5A. In some embodiments, the denier can decrease from fibers 200 to 204 to 208 such that the denier profile, illustrated in FIG. 5B, includes a portion having an increasing slope. In some embodiments, the denier can decrease from fibers 200 to 204 to 208 such that the denier profile, illustrated in FIG. 5C, includes a portion having a decreasing slope. In some embodiments, the denier can decrease from fibers 200 to 204 to 208 such that the denier profile, illustrated in FIG. 5D, includes a portion having an exponential slope, where the exponent is a number different than 1. In some embodiments, the denier can increase from fibers 200 to 204 to 208 such that the denier profile, illustrated in FIG. 5E, includes a portion having an increasing slope and a portion with a decreasing slope. In some embodiments, the denier can vary from fibers 200 to 204 to 208 such that the denier profile, illustrated in FIG. 5F, includes a bimodal shape.

In some embodiments, one or more the fibers (108, 112, 116, 180, 184, 188, 200, 204, 208) can form a non-woven and/or non-knitted material to thus form all or a portion of the filter media 80. The non-woven and/or non-knitted material can describe materials that are bonded together by chemical, mechanical, heat or solvent treatments, rather than by knitting or weaving. The non-woven material can be lofty, carded, air-laid or mechanically bonded (such as spun-lace, needle-entangled or needle-tacked). The non-woven material can be bonded (e.g., the fibers are bonded to one another at various locations) or non-bonded.

One or more the fibers (108, 112, 116, 180, 184, 188, 200, 204, 208), or another component of the filter media 80, can include a heat-setting material or a melt material that provides some or all of the bonding in the non-woven material and/or filter media 80, such as a flake, powder, fiber or a combination thereof. The heat-setting material can include any suitable thermoplastic or thermoset polymer, such as polyester, polyethylene terephthalate (PET), polypropylene (PP) or a combination thereof. After melting and/or heat bonding, the flake, powder and/or fiber can melt and bond fibers (108, 112, 116, 180, 184, 188, 200, 204, 208) together, increasing a strength and stability of the filter media 80.

The filter media 80 and fibers (108, 112, 116, 180, 184, 188, 200, 204, 208) can include a Flame-Resistant (FR) material, Oxidized Polyacrylonitrile fiber (OPAN), modacrylic, flame-resistant rayon, Polyacrylonitrile (PAN), Polyphenylene Sulfide (PPS), Polyethylene Terephthalate (PET), Polypropylene (PP), Kapok Fiber, Poly Lactic Acid (PLA), cotton, nylon, polyester, rayon (e.g., non-flame-retardant rayon), wool, basalt, fiberglass, ceramic or a combination thereof. In some embodiments, the filter media 80 and fibers (108, 112, 116, 180, 184, 188, 200, 204, 208) can include a conventional filter media material (such as polyolefin) that has been treated or coated to be flame-resistant, a conventional filter media material and a metal mesh and/or a flame-resistant barrier. In some embodiments, the fibers (108, 112, 116, 180, 184, 188, 200, 204, 208) can be bicomponent fibers, or fibers made of more than one material, such as those listed in this disclosure. In various embodiments, the filter media 80 can be pleated, non-pleated and/or multilayered, based upon application.

The filter media 80 and fibers (108, 112, 116, 180, 184, 188, 200, 204, 208) can further include a coating, a heat-setting or melt material (e.g., powder, flakes and/or fibers), a metal fiber, a glass fiber, a ceramic fiber, an aramid fiber, a sorbent, an intumescent material (e.g., a fiber or a particle), mica, diatomaceous earth, glass bubbles, carbon particles or a combination thereof. Examples of flame-resistant materials include any polymer designated as flame-retardant (e.g., as pure materials or as compounds including the materials), aluminum, polyphosphate, phosphorus, nitrogen, sulfur, silicon, antimony, chlorine, bromine, magnesium, zinc, carbon or a combination thereof. Flame-resistant materials can be halogen-containing flame retardants or non-halogenated flame retardants. Examples of coatings or additives can include expandable graphite, vermiculite, ammonium polyphosphate, alumina trihydrate (ATH), magnesium hydroxide (Mg(OH)2), aluminum hydroxide (Al(OH)3), molybdate compounds, chlorinated compounds, brominated compounds, antimony oxides, organophosphorus compounds or a combination thereof.

In some embodiments, the filter media 80 and fibers (108, 112, 116, 180, 184, 188, 200, 204, 208) can include airlaid nonwoven web prepared using 90% oxidized polyacrylonitrile (OPAN) staple fiber with a denier diameter of 5.0 dtex×60 mm (commercially available under the trade designation ZOLTEK™ OX) and 10% binding fiber (high temperature polyester melty fiber with a denier diameter of 6.7 dtex×60 mm, commercially available under the trade designation TREVIRA® T270) with an area weight of 150 grams per square meter.

In some embodiments, the filter media 80 and fibers (108, 112, 116, 180, 184, 188, 200, 204, 208) can include airlaid nonwoven web prepared using nylon staple fiber with a denier diameter of 1000 dtex and 10% binding fiber (commercially available under the trade designation TREVIRA® T270) with an area weight of 550 grams per square meter.

In some embodiments, the filter media 80 and fibers (108, 112, 116, 180, 184, 188, 200, 204, 208) can include airlaid nonwoven web prepared using 40% 5.0 dtex×60 mm OPAN staple fiber, 40% 500 dtex PET staple fiber (commercially available from David Poole), and 20% 15 dtex binding fiber, with an area weight of 225 grams per square meter.

In various embodiment, the filter media 80, first zone 120, second zone 132 and/or third zone 144 can have any suitable overall density, such as about, less than, equal to or greater than: 20, 40, 60, 80, 100, 125, 150, 175, 200, 225, 250, 275, 300, 325, 350, 375 or 400 g/m². The OPAN, FR rayon or a combination thereof, can be greater than, less than, equal to or about: 10, 20, 30, 40, 50, 60, 70, 80, 90 or 100 wt % of the filter media 80.

In some embodiments, the filter media 80 can be charged with an electrical charge, not charged or intermittently charged. In some embodiments, the filter media 80 can be designed to be used (sufficiently saturated with airborne particulates) one time and discarded, washed once sufficiently saturated and re-used, or washed once sufficiently saturated and re-used a pre-specified and finite number of times.

The present disclosure provides a filter media 80 and a filter securement system 90 with enhanced utility, lifespan, absorption properties and efficiency. In particular, airborne particulates (such as grease) in a fluid flow can exist in different sizes, masses, weights, shapes or other measurable metrics. In a conventional filter, having a substantially uniform density and/or fiber denier throughout, the intake side (or the side facing the incoming fluid flow) can become clogged or saturated with airborne particulates as particulates of all sizes fill the spaces between the fibers and/or areas within the fibers. After this, more downstream portions of the filter may receive decreased amounts of flow because of the blockage at or near the intake side, causing a pressure drop downstream of the filter media relative to a pressure upstream of the filter. Accordingly, the downstream portions of the filter are not used to their full potential before the conventional filter must be replaced or cleaned.

In contrast, the present disclosure provides a filter media 80 having fibers 108 of differing deniers, as described above. Such arrangements can provide enhanced functionality as, surprisingly, smaller airborne particulates can pass through the higher denier (and forming a less-dense web) fibers closer to the intake side 100 while getting trapped by the lower denier (and forming a more-dense web) fibers closer to the exhaust side 104. The present disclosure enables increased utility and functionality over a conventional filter.

Additionally, the present disclosure provides a filter media 80 that enables far better performance (such as facilitating more grease/airborne particulate filtration and absorption) than a conventional filter media while maintaining the weight and/or overall size of the conventional filter media. Further, the present disclosure provides a simplified filter media 80, as multiple conventional filter media portions would be needed to match the performance of the disclosed filter media 80 enabled by varying fiber deniers, as described above, thereby increasing costs, complexity, size, weight and difficulty of handling and securing.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure. The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control.

What is claimed is:

1. A filter media, comprising:
an intake side;
an exhaust side; and
a plurality of fibers distributed throughout the filter media, the fibers having a plurality of deniers,
wherein fibers disposed proximate the intake side have a first denier and fibers disposed proximate the exhaust side have a second denier, the first denier being larger than the second denier.

2. The filter media of claim 1, wherein the first denier is 200%-5,000% greater than the second denier, inclusive.

3. The filter media of claim 1, wherein fibers disposed at the intake side have a denier larger than that of fibers disposed at the exhaust side.

4. The filter media of claim 1, wherein the fibers are non-woven.

5. The filter media of claim 1, wherein the filter media includes two zones measured along a thickness direction of the filter media from the intake side to the exhaust side, wherein at least some fibers in the first zone have a first zone denier and at least some fibers in the second zone have a second zone denier, the first zone denier being larger than the second zone denier.

6. The filter media of claim 5, wherein the first zone denier is from 200%-2,000% greater than the second zone denier, inclusive.

7. The filter media of claim 5, wherein the filter media includes a third zone measured along a thickness direction of the filter media from the intake side to the exhaust side, wherein at least some fibers in the third zone have a third zone denier, the second zone denier being larger than the third zone denier.

8. The filter media of claim 7, wherein the second zone denier is from 200%-2,000% greater than the third zone denier, inclusive.

9. The filter media of claim 5, wherein a majority of fibers in the first zone have the first zone denier and a majority of fibers in the second zone have the second zone denier.

10. The filter media of claim 1, wherein the filter media defines a fiber denier profile as measured from the intake side to the exhaust side.

11. The filter media of claim 10, wherein the fiber denier profile includes a portion having a substantially constant slope.

12. The filter media of claim 10, wherein the fiber denier profile includes a portion having an increasing slope.

13. The filter media of claim 10, wherein the fiber denier profile includes a portion having a decreasing slope.

14. The filter media of claim 10, wherein the fiber denier profile includes a portion having an exponentially-changing slope, the exponent being a number different than 1.

15. The filter media of claim 10, wherein the fiber denier profile includes a bi-modal distribution.

16. The filter media of claim 10, wherein the fiber denier profile includes a portion having an increasing slope and a portion having a decreasing slope.

17. The filter media of claim 1, wherein at least some of the fibers include airlaid nonwoven fibers including oxidized polyacrylonitrile staple fibers and polyester fibers.

18. The filter media of claim 1, wherein at least some of fibers include airlaid nonwoven nylon staple fibers and polyester fibers.

19. The filter media of claim 1, wherein at least some of the fibers include oxidized polyacrylonitrile staple fibers, polyethylene terephthalate fibers, FR polyester fibers, bicomponent fibers and polyester fibers.
